(19) United States
(12) Patent Application Publication
(10) Pub. No.: US 2022/0154951 A1
(43) Pub. Date: May 19, 2022

(54) MULTIFUNCTIONAL HUMIDIFYING DEVICE

(71) Applicant: Shenzhen qianzong technology co. LTD, Shenzhen (CN)

(72) Inventor: Feng Li, Jinshi (CN)

(21) Appl. No.: 17/667,557

(22) Filed: Feb. 9, 2022

(30) Foreign Application Priority Data
Jan. 24, 2022 (CN) 202210079047.6

(51) Int. Cl. F24F 6/12

(52) U.S. Cl. CPC F24F 6/12

(57) ABSTRACT

The present disclosure discloses a multifunctional humidifying device, which comprises a shell component which is a hollow cavity; a water tank provided in the shell component, in which an aqueous solution is provided; a circuit board and a fan which are provided in the shell component and below the water tank; an atomizer provided in the water tank, which atomizes the aqueous solution in the water tank; an atmosphere lamp provided in the water tank, which faces the air outlet; a detection device provided on the circuit board, which is capable of monitoring the air quality and/or temperature and humidity of the surrounding environment in real time; a button penetrating through the shell component, which is capable of controlling the switch and function setting of the humidifying device; an interface, which is provided on the circuit board and penetrates through of the shell component.

### TECHNICAL FIELD

The present disclosure relates to the technical field of humidifiers, in particular to a multifunctional humidifying device.

### BACKGROUND

Humidifier, which atomizes the water in the water tank by an ultrasonic atomizer to increase the humidity of the environment. In the water tank of the humidifier, essence raw materials can also be added to achieve the effects of humidification and aromatherapy. The existing humidifiers generally only have the function of increasing humidity indoors, and some humidifiers for increasing the lighting effect lead the light ray inside the humidifier out of the shell through the water level perspective hole. The Chinese patent with the publication number of CN208222740U provides an atmosphere lamp humidifier, which comprises an atomizer main body, a water tank and a water tank shell, wherein the lower end of the atomizer main body is detachably connected with the water tank. The water tank shell is sleeved on the outer wall of the water tank. The atomizer main body is internally provided with a light-emitting source. The water tank is made of light-transmitting material. The outer peripheral surface of the water tank is longitudinally provided with a groove shrinking along the radial direction of the shell. The water tank shell is provided with a gap which is longitudinally provided at the position corresponding to the groove. The part of longitudinal edge of the gap which is located at the outer layer of the water tank shell circumferentially extends with the same thickness to form a covered edge. A cover plate is inserted into the groove, and the cover plate is sandwiched between the covered edge and the groove. However, the atmosphere lamp humidifier provided by the patent has a relatively weak light guiding effect, which can only form a light effect near the humidifier body, cannot create a rich humidifying light atmosphere, and has a relatively simple function. Therefore, in view of the deficiency of incineration in actual production, implementation and use of the above scheme, it is revised and improved. At the same time, with the help of professional knowledge and experience, this design is created with the spirit and idea of seeking excellence after many ingenious thoughts and experiments, so that a multifunctional humidifying device is provided to solve the above problems.

### SUMMARY

One of the purposes of the present disclosure is to provide a multifunctional humidifying device to solve the above problems.

The multifunctional humidify device of the present disclosure can be realized by the follow technical scheme.

The present disclosure relates to a multifunctional humidify device, comprising a shell component which is a hollow cavity, wherein the upper end of the shell component is provided with an air outlet and the lower end of the shell component is provided with a vent hole; a water tank provided in the shell component, in which an aqueous solution is provided; a circuit board and a fan which are provided in the shell component and below the water tank, wherein the circuit board is provided with a wireless communication module, and the wireless communication module is capable of being wirelessly connected with an electronic terminal; an atomizer provided in the water tank, which atomizes the aqueous solution in the water tank; an atmosphere lamp provided in the water tank, which faces the air outlet; a detection device provided on the circuit board, which is capable of monitoring the air quality and/or temperature and humidity of the surrounding environment in real time; a button penetrating through the shell component, which is capable of controlling the switch and function setting of the humidifying device; an interface, which is provided on the circuit board and penetrates through of the shell component, wherein the circuit board is electrically connected with the atomizer, the atmosphere lamp, the detection device, the fan, the button and the interface, respectively.

In one embodiment, the shell component comprises an upper shell and a lower shell, the upper shell is detachably connected with the lower shell, the water tank is fixedly connected with the lower shell, and the upper shell is movably sleeved on the water tank.

In one embodiment, the upper shell is provided with a hollow hole through which the water level in the water tank is capable of being observed in real time.

In one embodiment, the shape of the hollow hole is a pattern, a letter or a number.

In one embodiment, the sides of the hollow hole are provided with scales.

In one embodiment, the water tank comprises a water tank main body and a water tank cover, the water tank main body is a hollow cavity made of transparent or semitransparent material, and the water tank cover is detachably provided on the water tank main body.

In one embodiment, at least one positioning column is provided inside the upper shell, at least one positioning hole is provided on the front surface of the water tank cover, and the positioning column is matched with the corresponding positioning hole.

In one embodiment, the water tank main body is provided with a waterproof cavity and a wind outlet, the waterproof cavity is opposite to the air outlet, a water baffle is provided on the waterproof cavity, the water baffle is made of transparent or semitransparent materials, the waterproof cavity and the water baffle form a sealed cavity, and the atmosphere lamp is provided in the sealed cavity.

In one embodiment, a foot pad is provided at the bottom of the lower shell, the foot pad is made of silica gel; the lower shell is further provided with an interface hole, and the interface penetrates through the shell component through the interface hole.

In one embodiment, the wireless communication module is a Bluetooth wireless communication module or a WiFi wireless communication module.

In one embodiment. an alarm device, which is a speaker or a buzzer, is further provided in the shell component, and the alarm device is electrically connected with the circuit board.

In one embodiment, a gravity sensor is provided below the water tank, and the gravity sensor is electrically connected with the circuit board and monitors the weight of the water tank in real time.

In one embodiment, the water tank is provided with a liquid level sensor or an infrared sensor, and the liquid level sensor or the infrared sensor is electrically connected with the circuit board and monitors the liquid level of the water tank in real time.

In one embodiment, the atomizer comprises a fixing frame and an atomizer main body, the fixing frame is fixedly provided in the lower shell, the atomizer main body is fixedly provided on the fixing frame and penetrates through the water tank, and the atomizer main body uses an ultrasonic atomizer.

In one embodiment, a waterproof ring is provided at the part where the atomizer main body is in contact with the water tank, and the waterproof ring, is made of silica gel.

In one embodiment, the atmosphere lamp uses an LED lamp board, a plurality of LED lamps are uniformly provided on the LED lamp board, and the plurality of LED lamps are controlled to be changed into different colors through the circuit board.

In one embodiment, the detection device is one or more of a temperature and humidity detection device, a PM2.5 detection device, a formaldehyde detection device and a CO₂ detection device.

In one embodiment, the button is a touch display screen or a mechanical button.

In one embodiment, the aqueous solution in the water tank is added with essence raw materials.

In one embodiment, the interface is a power interface or a charging interface, a rechargeable battery is further provided in the shell component when the interface is a charging interface, and the battery is electrically connected with the circuit board.

Compare with that prior art, the multifunctional humidifying device has the following beneficial effect.

The multifunctional humidifying device of the present disclosure irradiates atomized water vapor via the light ray emitted by the atmosphere lamp through the water baffle, the water tank cover opening and the air outlet in sequence. At the same time, the light ray of the atmosphere lamp can also be transmitted out through the water tank and the hollow hole in sequence, thereby realizing the function of creating atmosphere by changing the color of the atmosphere lamp. Through the real-time monitoring of various detection devices, the air quality and/or temperature and humidity of the surrounding environment can be detected at the same time, and an alarm can be given in case of abnormality. At the same time, the wireless communication module is wirelessly connected with the electronic terminal, and the APP on the electronic terminal can control the humidifying device to work, thus effectively realizing the function of intelligent control, thus enabling the device to have various practical functions.

### BRIEF DESCRIPTION OF THE DRAWINGS

In order to explain the technical scheme of the embodiments of the present disclosure more clearly, the drawings needed in the embodiments will be briefly introduced hereinafter. It should be understood that the following drawings only show some embodiments of the present disclosure, so that they should not be regarded as limiting the scope. For those skilled in the art, other related drawings can be obtained according to these drawings without creative efforts.

FIG. 1 is a schematic structural diagram of a multifunctional humidifying device according to the present disclosure.

FIG. 2 is a structural diagram of another side of a multifunctional humidifying device according to the present disclosure shown in FIG. 1.

FIG. 3 is a schematic diagram of an explosion structure of a multifunctional humidifying device according to the present disclosure shown in FIG. 1.

FIG. 4 is a schematic diagram of an explosion structure of another side of a multifunctional humidifying device according to the present disclosure shown in FIG. 3.

FIG. 5 is a schematic structural diagram of an upper shell of a multifunctional humidifying device according to the present disclosure shown in FIG. 3.

FIG. 6 is a schematic structural diagram of a water tank main body in a multifunctional humidifying device according to the present disclosure shown in FIG. 3.

FIG. 7 is a schematic structural diagram of a water tank cover in a multifunctional humidifying device according to the present disclosure shown in FIG. 3.

Reference numbers in the drawing: 11. Shell component; 111. Upper shell; 1111. Air outlet; 1112. Hollow hole; 1113. Positioning column; 112. Lower shell; 1121. Foot pad; 1122. Vent hole; 1123. Interface hole; 12. Water tank; 121. Water tank main body; 1211. Waterproof cavity; 1212. Wind outlet; 122. Water tank cover; 1221. Water tank cover opening; 1222. Fastener; 1223. Positioning hole; 13. Circuit board; 14. Atomizer; 141. Fixing frame; 142. Atomizer main body; 15. Atmosphere lamp; 151. Water baffle; 16. Detection device; 17. Fan; 18. Button; 19. Interface.

### DETAILED DESCRIPTION OF THE EMBODIMENTS

In order to make the purpose, technical scheme and advantages of the embodiments of the present disclosure clearer, the technical scheme in the embodiments of the present disclosure will be clearly and completely described with reference to the drawings in the embodiments of the present disclosure hereinafter. Obviously, the described embodiments are part of the embodiments of the present disclosure, rather than all of the embodiments. Components of embodiments of the present disclosure generally described and shown in the drawings herein can be arranged and designed in various different configurations.

Therefore, the following detailed description of the embodiments of the present disclosure provided in the drawings is not intended to limit the scope of the claimed present disclosure, but only to represent selected embodiments of the present disclosure. Based on the embodiments in the present disclosure, all other embodiments obtained by those skilled in the art without creative efforts fall within the scope of protection of the present disclosure.

It should be noted that similar numbers and letters indicate similar items in the following drawings, so that once an item is defined in one drawing, it does not need to be further defined and explained in the following drawings.

In the description of the present disclosure, it should be noted that the orientation or positional relationship indicated by the terms “upper” and “lower” is based on the orientation or positional relationship shown in the drawings, or the orientation or positional relationship that the product of the present disclosure is usually placed when in use, which is only for the convenience of describing the present disclosure and simplifying the description, rather than indicating or implying that the indicated device or element must have a specific orientation, be constructed and operated in a specific orientation, so that it cannot be understood as a limitation of the present disclosure.

In addition, in the present disclosure, unless otherwise explicitly specified and limited, the first feature above or below the second feature may comprise the fact that the first feature is in direct contact with the second feature, or the first feature is not in direct contact with the second feature but is in contact through another feature between the first feature and the second feature. Furthermore, the first feature is above, on top of and on the second feature, which comprises the fact that the first feature is directly above and obliquely above the second feature, or simply indicates that the horizontal height of the first feature is higher than that of the second feature. The first feature is below, under and underneath the second feature, which comprises the fact that the first feature is directly below and obliquely below the second feature, or simply indicates that the horizontal height of the first feature is less than that of the second feature.

In addition, the terms such as “horizontal” and “vertical” do not mean that the components are required to be absolutely horizontal or vertical, but can be slightly inclined. For example, “horizontal” only means that its direction is more horizontal than “vertical”, which does not mean that the structure must be completely horizontal, but can be slightly inclined.

In the description of the present disclosure, it should be noted that the terms such as “providing”, “linking” and “connecting” should be understood broadly, for example, they can be fixed connection, detachable connection or integrated connection; they can be mechanical connection or electrical connection; they can be direct connection, or indirect connection through an intermediate medium, or the internal communication of two elements. For those skilled in the art, the specific meanings of the above terms in the present disclosure can be understood in specific situations.

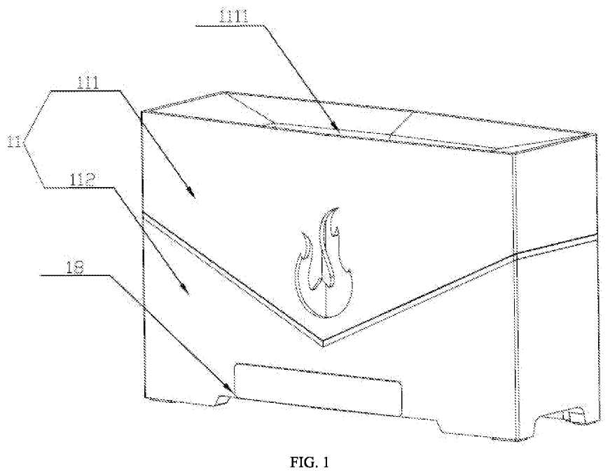

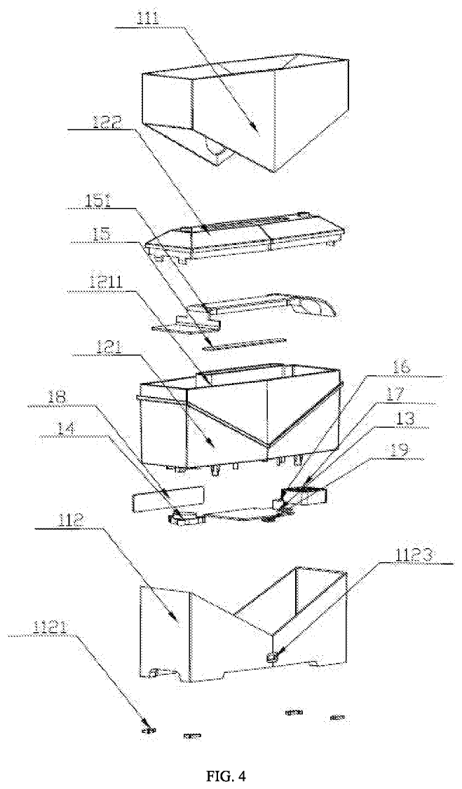

As shown in FIGS. 1-4, a multifunctional humidifying device of the present disclosure can comprise a shell component 11, a water tank 12, a circuit board 13, an atomizer 14, an atmosphere lamp 15, a detection device 16, a fan 17, a button 18 and an interface 19. The shell component 11 is a hollow cavity, wherein the upper end of the shell component is provided with an air outlet 1111 and the lower end of the shell component is provided with a vent hole 1122. The water tank 12 is provided in the shell component 11, in which an aqueous solution is provided. The circuit board 13 and the fan 17 are provided in the shell component 11 and below the water tank 13. The circuit board 13 is electrically connected with the atomizer 14, the atmosphere lamp 15, the detection device 16, the fan 17, the button 18 and the interface 19, respectively. The fan 17 is used to blow away the water vapor of aqueous solution atomized by the atomizer 14 in the water tank 12 from the air outlet 1111. The atomizer 14 is provided in the water tank 12, which atomizes the aqueous solution in the water tank 12. The atmosphere lamp 15 is provided in the water tank 12, which faces the air outlet 1111. The light ray emitted by the atmosphere lamp 15 is transmitted through the air outlet 1111. The detection device 16 is provided on the circuit board 13, which is capable of monitoring the air quality and/or temperature and humidity entering the shell component 11 from the vent hole 1122 in real time. The button 18 is electrically connected with the circuit board 13 and penetrates through the shell component 11, which is capable of controlling the switch and function setting of the humidifying device. The interface 19 is provided on the circuit board 13 and penetrates through the shell component 11, which is used to supply power to the circuit board 19.

As shown in FIGS. 1-5, in this embodiment, the shape of the shell component 11 is a hollow rectangle. In other embodiments, the shape of the shell component 11 can also be cylindrical or other shapes. In this embodiment, the shell component 11 comprises an upper shell 111 and a lower shell 112. The upper shell 111 is detachably connected with the lower shell 112. The water tank 12 is fixedly connected with the lower shell 112. The upper shell 111 is movably sleeved on the water tank 12. In some embodiments, the water tank 12 can also be detachably connected with the lower shell 112. The upper shell 111 is movably sleeved on the water tank 12. In this embodiment, the upper shell 111 is provided with a hollow hole 1112, through which the water level in the water tank 12 can be observed in real time. The shape of the hollow hole 1112 can be a pattern, a letter or a number. In this embodiment, the shape of the hollow hole 1112 is flame-shaped. In some embodiments, the sides of the hollow hole 1112 may also be provided with scales, through which the volume of the aqueous solution in the water tank 12 can be measured. At least one positioning column 1113 is provided inside the upper shell 111, and it is convenient to install the upper shell 111 on the water tank 12 through the at least one positioning column 1113. In this embodiment, two positioning columns 1113 are symmetrically provided inside the upper shell 111. In this embodiment, a foot pad 1121 is provided at the bottom of the lower shell 112. The foot pad 1121 is made of silica gel. The lower shell 112 is further provided with an interface hole 1123, and the interface 19 penetrates through the shell component 11 through the interface hole 1123.

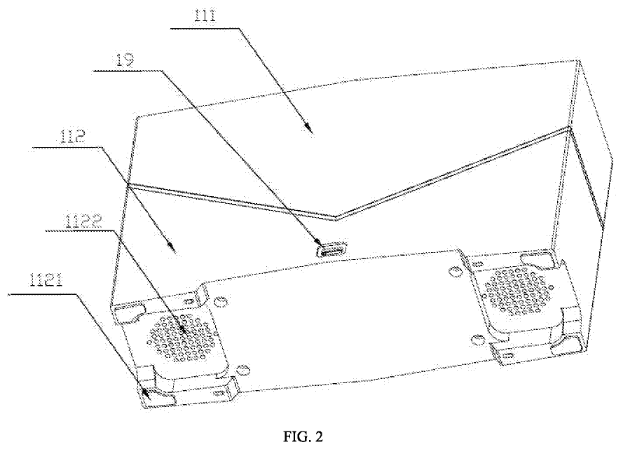

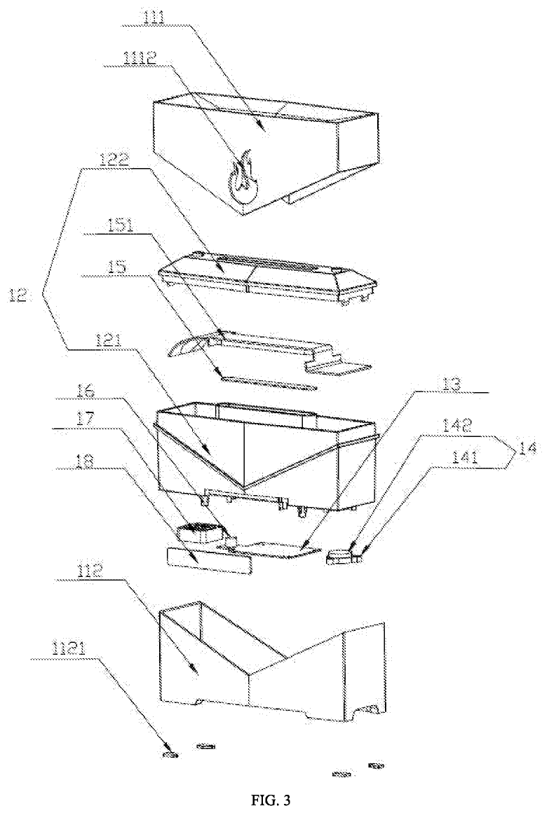

As shown in FIG. 2 and FIG. 3, in this embodiment, the water tank 12 comprises a water tank main body 121 and a water tank cover 122. The water tank main body 121 is a hollow cavity made of transparent or semitransparent material, and the water tank cover 122 is detachably provided on the water tank main body 121.

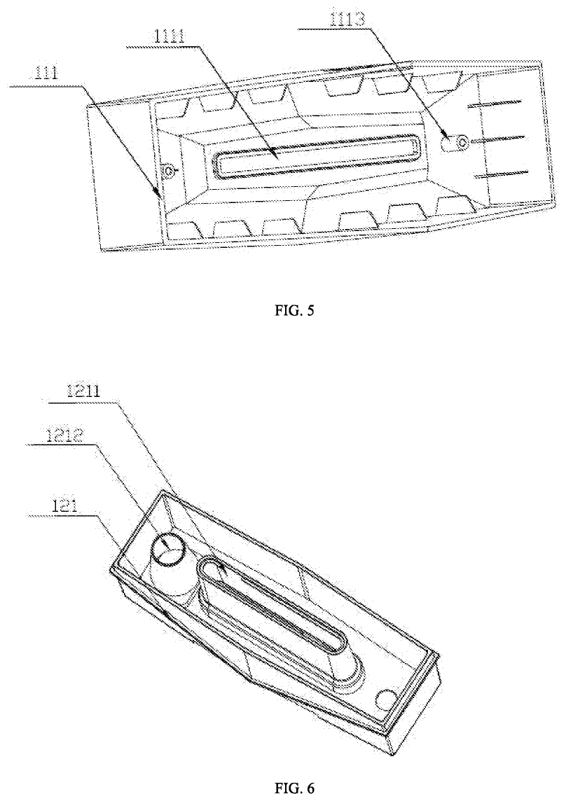

As shown in FIG. 2 and FIG. 6, in this embodiment, the water tank main body 121 is provided with a waterproof cavity 1211 and a wind outlet 1212. The waterproof cavity 1211 is opposite to the air outlet 1111, and a water baffle 151 is provided on the waterproof cavity. The water baffle 151 is made of transparent or semitransparent materials. The waterproof cavity 1211 and the water baffle 151 form a sealed cavity, so as to prevent the aqueous solution in the water tank 12 from entering the waterproof cavity 1211. The atmosphere lamp 15 is provided in the sealed cavity, and the light ray emitted by the atmosphere lamp is projected from the air outlet 1111 through the water baffle 151. The air outlet 1212 is provided directly above the fan 17. The fan 17 blows outside air into the water tank 12 through the vent hole 1112 and the air outlet 1212 in sequence, so that the water vapor atomized in the water tank 12 is blown out from the air outlet 1111. In this embodiment, the aqueous solution in the water tank 12 is added with essence raw materials, so as to achieve the effects of humidification and aromatherapy.

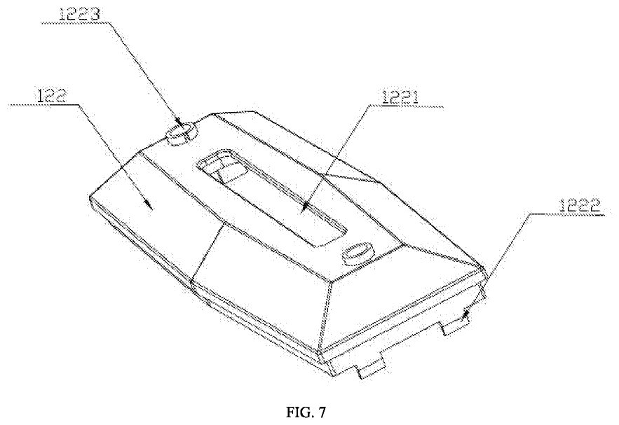

As shown in FIGS. 2 and 7, in this embodiment, the water tank cover 122 is provided with a water tank cover opening 1221, a plurality of fasteners 1222 and at least one positioning hole 1223. The water tank cover opening 1221 is provided between the air outlet 1111 and the waterproof cavity 1211. The light ray emitted by the atmosphere lamp 15 in the waterproof cavity 1211 irradiates atomized water vapor through the water baffle 151, the water tank cover opening 1221 and the air outlet 1111 in sequence. The plurality of fasteners 1222 are provided at the lower end of the water tank cover 122, which are matched with corresponding necks on the water tank main body 121, respectively, so as to fix the water tank cover 122 on the water tank main body 121. The at least one positioning hole 1223 is provided on the front surface of the water tank cover 122, and its position is matched with the corresponding positioning column 1113, respectively, so that the upper shell 111 is fixed on the water tank 12.

As shown in FIG. 2 and FIG. 3, the circuit board 13 is electrically connected with the atomizer 14, the atmosphere lamp 15, the detection device 16, the fan 17, the button 18 and the interface 19, respectively. The control technology used by the circuit board is the existing technology, which will not be described in detail here. In this embodiment, the circuit board 13 is provided with a wireless communication module. The wireless communication module can be wirelessly connected with the electronic terminal. The APP on the electronic terminal can control the humidifying device to work. The wireless communication module can be a Bluetooth wireless communication module or a WiFi wireless communication module. Preferably, the wireless communication module can be a Bluetooth wireless communication module. In some embodiments, the shell component 11 can also be provided with an alarm device. The alarm device is electrically connected with the circuit board 13. When the data monitored by the detection device 16 exceeds a preset value, an alarm can be given by the alarm device. The alarm device can be a speaker or a buzzer. In some embodiments, a gravity sensor can be provided below the water tank 12, and the gravity sensor is electrically connected with the circuit board 13. The control technology used by the gravity sensor is the existing technology, which will not be described in detail here. The weight of the water tank 12 can be monitored in real time by the gravity sensor. When the weight of the water tank 12 is less than a preset value, an alarm can be given by the alarm device to remind users to add aqueous solution. In other embodiments, the water tank 12 may also be provided with a liquid level sensor or an infrared sensor. The liquid level sensor or the infrared sensor is electrically connected with the circuit board 13. The control technology used by the liquid level sensor or the infrared sensor is the existing technology, which will not be described in detail here. The liquid level sensor or the infrared sensor monitors the liquid level of the water tank 12 in real time. When the liquid level of the water tank 12 is lower than a preset value, an alarm can be given by the alarm device to remind users to add aqueous solution.

As shown in FIG. 2 and FIG. 3, in this embodiment, the atomizer 14 comprises a fixing frame 141 and an atomizer main body 142. The fixing frame 141 is fixedly provided in the lower shell 111. The atomizer main body 142 is fixedly provided on the fixing frame 141 and penetrates through the water tank 12. In order to better prevent water, a waterproof ring is provided at the part where the atomizer main body 142 is in contact with the water tank 12, and the waterproof ring is made of silica gel. Specifically, the atomizer main body 142 uses an ultrasonic atomizer.

As shown in FIG. 2 and FIG. 3, in this embodiment, the atmosphere lamp 15 uses an LED lamp board, and a plurality of LED lamps are uniformly provided on the LED lamp board. The plurality of LED lamps can be controlled to be changed into different colors through the circuit board 13. The control technology used by the circuit board is the existing technology, which will not be described in detail here. The light ray emitted by the atmosphere lamp 15 irradiates the atomized water vapor through the water baffle 151, the water tank cover opening 1221 and the air outlet 1111 in sequence. At the same time, the light ray of the atmosphere lamp 15 can be transmitted through the water tank 12 and the hollow hole 1112 in sequence, and different atmospheres can be created by changing the color of the atmosphere lamp 15.

As shown in FIGS. 2 and 3, the detection device 16 can be one or more of a temperature and humidity detection device, a PM2.5 detection device, a formaldehyde detection device and a CO₂ detection device. In this embodiment, the detection device 16 uses a temperature and humidity detection device and a PM2.5 detection device. In this embodiment, the button 18 may be a touch screen. The temperature, humidity and PM2.5 concentration at the placement position can be displayed by the touch screen. At the same time, function settings can be made by touch. In other embodiments, the button 18 may also be a mechanical button. The mechanical button is provided on the circuit board 13 and penetrates through the shell component 11.

As shown in FIG. 2 and FIG. 5, in this embodiment, the interface 19 is a power interface. Both ends of the power cord are connected with the mains and the interface 19 to supply power. In other embodiments, the shell component 11 is provided with a rechargeable battery. The battery is electrically connected with the circuit board 13. The battery is charged through the interface 19. The interface 19 can uses a Micro USB interface, a USB Type C interface or a Lightning interface. Preferably, the interface 19 uses a USB Type C interface. The battery can be a 18650 battery or a polymer lithium ion battery.

It should be noted that the multifunctional humidifying device of the present disclosure irradiates atomized water vapor via the light ray emitted by the atmosphere lamp 15 through the water baffle 151, the water tank cover opening 1221 and the air outlet 1111 in sequence. At the same time, the light ray of the atmosphere lamp 15 can also be transmitted out through the water tank 12 and the hollow hole 1112 in sequence, thereby creating different atmospheres by changing the color of the atmosphere lamp 15. The detection device 16 can monitor the air quality and/or temperature and humidity of the surrounding environment in real time, and can be wirelessly connected with the electronic terminal through the wireless communication module. The APP on the electronic terminal can control the humidifying device to work.

The technical features of the above embodiments can be arbitrarily combined. For the sake of brevity, not all possible combinations of the technical features of the above embodiments are described. However, as long as there is no contradiction between the combinations of these technical features, they should be considered as the scope recorded in this specification.

The above embodiments only express several implementations of the present disclosure, which are described specifically in detail, but cannot be understood as limiting the patent scope of present disclosure. It should be pointed out that for those skilled in the art, several changes and improvements can be made without departing from the concept of the present disclosure, which fall within the scope of protection of the present disclosure. Therefore, the scope of protection of the patent of the present disclosure should be subject to the appended claims.

What is claimed is:

1. A multifunctional humidifying device, comprising a shell component which is a hollow cavity, wherein the upper end of the shell component is provided with an air outlet and the lower end of the shell component is provided with a vent hole; a water tank provided in the shell component, in which an aqueous solution is provided; a circuit board and a fan which are provided in the shell component and below the water tank, wherein the circuit board is provided with a wireless communication module, and the wireless communication module is capable of being wirelessly connected with an electronic terminal; an atomizer provided in the water tank, which atomizes the aqueous solution in the water tank; an atmosphere lamp provided in the water tank, which faces the air outlet; a detection device provided on the circuit board, which is capable of monitoring the air quality and/or temperature and humidity of the surrounding environment in real time; a button penetrating through the shell component, which is capable of controlling the switch and function setting of the humidifying device; an interface, which is provided on the circuit board and penetrates through of the shell component, wherein the circuit board is electrically connected with the atomizer, the atmosphere lamp, the detection device, the fan, the button and the interface, respectively.

2. The multifunctional humidifying device according to claim 1, wherein the shell component comprises an upper shell and a lower shell, the upper shell is detachably connected with the lower shell, the water tank is fixedly connected with the lower shell, and the upper shell is movably sleeved on the water tank.

3. The multifunctional humidifying device according to claim 2, wherein the upper shell is provided with a hollow hole through which the water level in the water tank is capable of being observed in real time.

4. The multifunctional humidifying device according to claim 3, wherein the shape of the hollow hole is a pattern, a letter or a number.

5. The multifunctional humidifying device according to claim 4, wherein the sides of the hollow hole are provided with scales.

6. The multifunctional humidifying device according to claim 2, wherein the water tank comprises a water tank main body and a water tank cover, the water tank main body is a hollow cavity made of transparent or semitransparent material, and the water tank cover is detachably provided on the water tank main body.

7. The multifunctional humidifying device according to claim 6, wherein at least one positioning column is provided inside the upper shell, at least one positioning hole is provided on the front surface of the water tank cover, and the positioning column is matched with the corresponding positioning hole.

8. The multifunctional humidifying device according to claim 6, wherein the water tank main body is provided with a waterproof cavity and a wind outlet, the waterproof cavity is opposite to the air outlet, a water baffle is provided on the waterproof cavity, the water baffle is made of transparent or semitransparent materials, the waterproof cavity and the water baffle form a sealed cavity, and the atmosphere lamp is provided in the sealed cavity.

9. The multifunctional humidifying device according to claim 2, wherein a foot pad is provided at the bottom of the lower shell, the foot pad is made of silica gel; the lower shell is further provided with an interface hole, and the interface penetrates through the shell component through the interface hole.

10. The multifunctional humidifying device according to claim 1, wherein the wireless communication module is a Bluetooth wireless communication module or a WiFi wireless communication module.

11. The multifunctional humidifying device according to claim 1, wherein an alarm device, which is a speaker or a buzzer, is further provided in the shell component, and the alarm device is electrically connected with the circuit board.

12. The multifunctional humidifying device according to claim 11, wherein a gravity sensor is provided below the water tank, and the gravity sensor is electrically connected with the circuit board and monitors the weight of the water tank in real time.

13. The multifunctional humidifying device according to claim 11, wherein the water tank is provided with a liquid level sensor or an infrared sensor, and the liquid level sensor or the infrared sensor is electrically connected with the circuit board and monitors the liquid level of the water tank in real time.

14. The multifunctional humidifying device according to claim 2, wherein the atomizer comprises a fixing frame and an atomizer main body, the fixing frame is fixedly provided in the lower shell, the atomizer main body is fixedly provided on the fixing frame and penetrates through the water tank, and the atomizer main body uses an ultrasonic atomizer.

15. The multifunctional humidifying device according to claim 14, wherein a waterproof ring is provided at the part where the atomizer main body is in contact with the water tank, and the waterproof ring is made of silica gel.

16. The multifunctional humidifying device according to claim 1, wherein the atmosphere lamp uses an LED lamp board, a plurality of LED lamps are uniformly provided on the LED lamp board, and the plurality of LED lamps are controlled to be changed into different colors through the circuit board.

17. The multifunctional humidifying device according to claim 1, wherein the detection device is one or more of a temperature and humidity detection device, a PM2.5 detection device, a formaldehyde detection device and a CO₂ detection device.

18. The multifunctional humidifying device according to claim 1, wherein the button is a touch display screen or a mechanical button.

19. The multifunctional humidifying device according to claim 1, wherein the aqueous solution in the water tank is added with essence raw materials.

20. The multifunctional humidifying device according to claim 1, wherein the interface is a power interface or a charging interface, a rechargeable battery is further provided in the shell component when the interface is a charging interface, and the battery is electrically connected with the circuit board.
